(19) United States
(12) Patent Application Publication
(10) Pub. No.: US 2013/0319673 A1
(43) Pub. Date: Dec. 5, 2013

(54) Cement Compositions Comprising Saponins and Associated Methods

(71) Applicants: Keith D. Pewitt, Duncan, OK (US); D. Chad Brenneis, Marlow, OK (US); Jeffery D. Karcher, Duncan, OK (US)

(72) Inventors: Keith D. Pewitt, Duncan, OK (US); D. Chad Brenneis, Marlow, OK (US); Jeffery D. Karcher, Duncan, OK (US)

(73) Assignee: HALLIBURTON ENERGY SERVICES, INC., Houston, TX (US)

(21) Appl. No.: 13/485,269

(22) Filed: May 31, 2012

(51) Int. Cl. E21B 33/13; C04B 16/00

(52) U.S. Cl. 166/294; 106/804

(57) ABSTRACT

A variety of methods and compositions are disclosed, including, in one embodiment, a method of cementing in a subterranean formation, comprising: introducing a cement composition into a subterranean formation, wherein the cement composition comprises cement, water, and a saponin; and allowing the cement composition to set in the subterranean formation.

### BACKGROUND

Cement compositions may be used in a variety of subterranean operations. For example, in subterranean well construction, a pipe string (e.g., casing, liners, expandable tubulars, etc.) may be run into a well bore and cemented in place. The process of cementing the pipe string in place is commonly referred to as “primary cementing.” In a typical primary cementing method, a cement composition may be pumped into an annulus between the walls of the well bore and the exterior surface of the pipe string disposed therein. The cement composition may set in the annular space, thereby forming an annular sheath of hardened, substantially impermeable cement (i.e., a cement sheath) that may support and position the pipe string in the well bore and may bond the exterior surface of the pipe string to the subterranean formation. Among other things, the cement sheath surrounding the pipe string functions to prevent the migration of fluids in the annulus, as well as protecting the pipe string from corrosion. Cement compositions also may be used in remedial cementing methods, for example, to seal cracks or holes in pipe strings or cement sheaths, to seal highly permeable formation zones or fractures, to place a cement plug, and the like.

Subterranean cementing operations generally occur under a wide variety of well bore conditions, for example, ranging from shallow wells (less than about 1,000 feet) to extremely deep wells (greater than about 35,000 feet). Generally, a cement composition that is to be used in subterranean cementing operations should have a thickening time that allows it to be placed into the desired location within the subterranean formation. As used herein, the term “thickening time” refers to the time required for the composition to reach 70 Bearden units of Consistency (“Bc”) as measured on a high-temperature high-pressure consistometer in accordance with the procedure for determining cement thickening times set forth in API RP 10B-2, Recommended Practice for Testing Well Cements, First Edition, July 2005. Set retarders often have been included in cement compositions, so as to lengthen the thickening time of the cement composition so that the cement composition can reach its ultimate location within the subterranean formation. As used herein, the phrase “set retarder” refers to a wide variety of compositions commonly used in cementing operations for delaying the set time of a cement composition, for example, by lengthening the thickening time thereof. Examples of set retarders that have been used include, for example, lignosulfonates, organic acids, phosphonic acid derivatives, maltodextrins, sulfonated aromatic polymers, synthetic polymers (e.g. copolymers of 2-acrylamido-2-methylpropane sulfonic acid (“AMPS”) with acrylic acid or itaconic acids), inorganic borate salts, and combinations thereof. However, set retarders such as those described above may be problematic in some instances. For example, the set retarders may have secondary effects that undesirably interact with foamed cement compositions and could cause undesirable breaking of the foam. By way of further example, certain of the set retarders may pose an undesired environmental risk in some instances. Thus, an ongoing need exists for set retarders that are effective and pose less environmental risk.

### SUMMARY

An embodiment of the present invention includes a method of cementing in a subterranean formation, comprising: introducing a cement composition into a subterranean formation, wherein the cement composition comprises cement, water, and a saponin; and allowing the cement composition to set in the subterranean formation.

Another embodiment of the present invention includes a method of a method of cementing in a subterranean formation, comprising: introducing a cement composition into a subterranean formation, wherein the cement composition comprises cement, water, and a yucca extract, wherein the yucca extract comprises yucca saponins.

Another embodiment of the present invention includes a cement composition comprising a cement, water, and a saponin.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to subterranean cementing operations and, more particularly, in certain embodiments, to cement compositions comprising cement and a saponin. Advantageously, the saponin may function to extend the thickening time of the cement composition. For example, cement compositions comprising the saponin may have a thickening time in a range of from about 1 to about 10 hours or more hours at a temperature in a range from about 60° F. to about 300° F. While the saponin may be effective for extending the thickening time of the cement compositions in a number of different applications, it may be particularly effective for extending the thickening time of foamed cement compositions as the saponin may not undesirably interact with the foam and may possible even facilitate foaming. Even further, as the saponin may be present in a food-grade material and be biodegradable, it may pose less environmental risk than certain set retarders that have been used heretofore.

Embodiments of the cement compositions may comprise a saponin. The term “saponin” refers to a class of chemical compounds found in natural sources. In general, saponins may comprise a hydrophobic component, comprising either a steroidal or a triterpenoid aglycone, and a water-soluble component. For example, the saponin may comprise a hydrophobic component having one or more chains that comprise a water-soluble carbohydrate. In some embodiments, the saponin may comprise one, two, or three chains of the water-soluble carbohydrate and, thus, may be classified as mono-, di-, or tri-desmosidic. While saponins suitable for use in embodiments of the present invention may be extracted from a variety of different plants, examples of saponins that may be used include, without limitation, yucca saponins and quillaja saponins, which may be extracted from the yucca plant and soap bark tree, respectively. Other saponins that may be used include, for example, saponins extracted from legumes (e.g., soybean saponins, chickpea saponins, peanut saponins, kidney bean saponins, etc.), oats, allium species, asparagus, tea, spinach, sugarbeet, yam, fenugreek, alfalfa, horse chestnut, licorice, soapwort, gypsophila genus, sarasparialla, and ginseng. Combinations of different saponins may also be used in embodiments of the present invention. A variety of different extraction techniques may be used for extraction of the saponins from the plant matrix. In some embodiments, solvent extraction techniques may be used for the extraction of the saponins, which may use, for example, water or alcohols (e.g., methanol, ethanol). Embodiments may further include further purification of the extract to more particularly isolate the saponins.

In some embodiments, the saponin functions as a set retarder. For example, the saponin can be included in the cement composition to extend the thickening time thereof. In additional embodiments, the saponin functions as a foaming agent. For example, the saponin can be included in the cement composition to facilitate the foaming of the cement composition. In particular embodiments, the saponin can have a dual function both as a set retarder and a foaming agent. In general, the saponin may be included in the cement composition in an amount sufficient to provide the desired extension of thickening time and/or foaming, for example. In some embodiments, the saponin may be present in an amount in a range of from about 0.01% to about 5% by weight of the cement. In particular embodiments, the saponin may be present in an amount ranging between any of and/or including any of about 0.01%, about 0.05%, about 0.1%, about 0.5%, about 1%, about 2%, about 3%, about 4% or about 5% by weight of the cement. One of ordinary skill in the art, with the benefit of this disclosure, will recognize the appropriate amount of the saponin to include for a chosen application.

In an embodiment, the saponin may comprise yucca saponins. Yucca saponins may generally comprise a steroid aglycone having one or more side chains that comprise water-soluble carbohydrates. In general, yucca saponins may be extracted from the yucca plant (yucca schidigera). In some embodiments, the yucca saponins may be extracted from the roots of the yucca plant in a manner that will be evident to one of ordinary skill in the art. Yucca extract may generally comprise yucca saponins in an aqueous base fluid. For example, the yucca extract may comprise yucca saponins in an amount in a range of from about 0.01% to about 25% by weight of the yucca extract and, alternatively, from about 5% to about 15% by weight of the yucca extract. In some embodiments, yucca extracts that comprise yucca saponins may be included in the cement compositions of the present invention. Yucca extracts have been used in a number of different commercial applications. For example, yucca extracts are commonly used as a consumable product for both humans and animals. In some instances, yucca extracts have been used for alternative medicines. It is believed that the yucca extract may have a beneficial effect, for example, on the digestive system when consumed. Examples of commercially available yucca extracts include, without limitation, Yucca AG AIDE, Yucca AG AIDE 20, and Yucca AG AIDE 50, available from Desert King International, San Diego, Calif.

Where present, the yucca extract may be included in the cement compositions in an amount sufficient to provide the desired extension of thickening time and/or foaming, for example. In some embodiments, the yucca extract may be present in an amount in a range of from about 0.01% to about 10% by weight of the cement. In particular embodiments, the yucca extract may be present in an amount ranging between any of and/or including any of about 0.01%, about 0.05%, about 0.1%, about 0.5%, about 1%, about 2%, about 3%, about 4%, about 5%, or about 10% by weight of the cement. One of ordinary skill in the art, with the benefit of this disclosure, will recognize the appropriate amount of the yucca extract to include for a chosen application.

In an embodiment, the saponin may comprise quillaja saponins. Quillaja saponins generally comprise a triterpenoid aglycone having one or more side chains that comprise water-soluble carbohydrates. The quillaja saponins generally may be extracted from the soap bark tree (quillaja saponaria). In some embodiments, the quillaja saponins may be extracted from the bark of the soapbark tree in a manner that will be evident to one of ordinary skill in the art. In accordance with present embodiments, quillaja extracts that comprise quillaja saponins may be included in cement compositions of the present invention. In some embodiments, the quillaja extracts may comprise quillaja saponins in an amount in a range of from about 0.01% to about 25% by weight of the quillaja extract and, alternatively, from about 5% to about 15% by weight of the quillaja extract. Quillaja extracts have been used in a number of different commercial applications. For example, quillaja extracts are commonly used as a consumable product for both humans and animals. In some instances, the quillaja extracts have been used in alternative medicines. It is believed that the quillaja extract may have a beneficial effect, for example, on the digestive system after consumption. Examples of commercially available yucca extracts include, without limitation, Quillaja Extract and Qillaja Ultra, both available from Desert King International, San Diego, Calif.

Where present, the quillaja extracts may be included in the cement compositions in an amount sufficient to provide the desired extension of thickening time and/or foaming, for example. In some embodiments, the quillaja extracts may be present in an amount in a range of from about 0.01% to about 10% by weight of the cement. In particular embodiments, the quillaja extracts may be present in an amount ranging between any of and/or including any of about 0.01%, about 0.05%, about 0.1%, about 0.5%, about 1%, about 2%, about 3%, about 4%, about 5%, or about 10% by weight of the cement. One of ordinary skill in the art, with the benefit of this disclosure, will recognize the appropriate amount of the quillaja extract to include for a chosen application.

Embodiments of the cement compositions of the present invention may comprise a cement. Any of a variety of cements suitable for use in subterranean cementing operations may be used in accordance with embodiments of the present invention. Suitable examples include hydraulic cements that comprise calcium, aluminum, silicon, oxygen and/or sulfur, which set and harden by reaction with water. Suitable hydraulic cements include, but are not limited to, Portland cements, pozzolana cements, gypsum cements, high alumina content cements, slag cements, silica cements, and combinations thereof In certain embodiments, the hydraulic cement may comprise a Portland cement, including Portland cements classified as Classes A, C, G and H cements according to American Petroleum Institute, API Specification for Materials and Testing for Well Cements, API Specification 10, Fifth Edition, Jul. 1, 1990. In addition, Portland cements suitable for use in embodiments the present invention may also include those classified as ASTM Type I, II, III, IV, or V.

Embodiments of the cement compositions may comprise water. The water may be fresh water or salt water. Salt water generally may include one or more dissolved salts therein and may be saturated or unsaturated as desired for a particular application. Seawater or brines may be suitable for use in embodiments of the present invention. Further, the water may be present in an amount sufficient to form a pumpable slurry. In some embodiments, the water may be included in the settable compositions of the present invention in an amount in the range of from about 40% to about 200% by weight of the cement. For example, the water may be present in an amount ranging between any of and/or including any of about 50%, about 75%, about 100%, about 125%, about 150%, or about 175% by weight of the cement. In specific embodiments, the water may be included in an amount in the range of from about 40% to about 150% by weight of the cement. One of ordinary skill in the art, with the benefit of this disclosure, will recognize the appropriate amount of water to include for a chosen application.

Other additives suitable for use in subterranean cementing operations also may be added to embodiments of the cement compositions. Examples of such additives include, but are not limited to, strength-retrogression additives, set accelerators, weighting agents, lightweight additives, gas-generating additives, mechanical property enhancing additives, lost-circulation materials, filtration-control additives, dispersants, fluid loss control additives, defoaming agents, foaming agents, thixotropic additives, and combinations thereof. By way of example, the cement composition may be a foamed cement composition further comprising a foaming agent and a gas. Specific examples of these, and other, additives include crystalline silica, amorphous silica, fumed silica, salts, fibers, hydratable clays, calcined shale, vitrified shale, microspheres, fly ash, slag, diatomaceous earth, metakaolin, rice husk ash, natural pozzolan, zeolite, cement kiln dust, lime, elastomers, resins, latex, combinations thereof, and the like. A person having ordinary skill in the art, with the benefit of this disclosure, will readily be able to determine the type and amount of additive useful for a particular application and desired result.

Those of ordinary skill in the art will appreciate that the cement compositions generally should have a density suitable for a particular application. By way of example, the cement compositions may have a density in the range of from about 4 pounds per gallon (“lb/gal”) to about 20 lb/gal. In certain embodiments, the cement compositions may have a density in the range of from about 8 lb/gal to about 17 lb/gal. Embodiments of the cement compositions may be foamed or unfoamed or may comprise other means to reduce their densities, such as hollow microspheres, low-density elastic beads, or other density-reducing additives known in the art. Those of ordinary skill in the art, with the benefit of this disclosure, will recognize the appropriate density for a particular application.

As previously mentioned, the cement compositions may have a set time that has been retarded in that they may have, for example, a thickening time that has been lengthened. In some embodiments, the saponin may function as a set retarder. In such embodiments, the cement composition may exclude other retarders thereby allowing the saponin to function as the primary retarder. In some embodiments, the cement compositions may have a thickening time of at least about 1 hour at a temperature in a range of from about 60° F. less than about 300° F. For example, the cement compositions may have a thickening time in a range of from about 1 hour to about 40 hours, alternatively, from about 3 hours to about 12 hours, and, alternatively from about 4 hours to about 10 hours at temperature in a range of from about 60° F. to about 300° F., alternatively, from about 80° F. to about 250° F., and alternatively from about from about 100° F. to about 200° F.

In some embodiments, the cement compositions may comprise an additional set retarder. A broad variety of additional set retarders may be suitable for use in embodiments of the cement compositions of the present invention. For example, the set retarder may comprise lignosulfonates, organic acids, phosphonic acid derivatives, maltodextrins, sulfonated aromatic polymers, synthetic polymers (e.g. copolymers of AMPS with acrylic acid or itaconic acids), inorganic borate salts, and combinations thereof. Where used, the additional set retarder may be present in the cement compositions in an amount in the range of from about 0.01% to about 10% by weight of the cement. In specific embodiments, the additional set retarder may be present in an amount ranging between any of and/or including any of about 0.01%, about 0.1%, about 1%, about 2%, about 4%, about 6%, about 8%, or about 10% by weight of the cement. One of ordinary skill in the art, with the benefit of this disclosure, will recognize the appropriate amount of the additional set retarder to include for a chosen application.

As previously mentioned, embodiments of the cement compositions may be foamed with a gas. In some embodiments, the cement compositions may be foamed to a density in a range of from about 4 lb/gal to about 16 lb/gal or, alternatively, from about 8 lb/gal to about 13 lb/gal. In some embodiments, the saponin may function as the foaming agent, thus facilitating the foaming of the cement composition. In such embodiments, the cement composition may exclude other foaming agents thereby allowing the saponin to function as the foaming agent. In some embodiments, the saponin may function as a set retarder in the foamed cement composition. Due to its foaming properties, the saponin may not undesirable interact with the resultant foam, thus making it useful for retarding the set of foamed cement compositions in a variety of applications. While the saponin may be useful in a variety of different foaming applications, it may be particularly useful in subterranean formations having bottom hole static temperatures less than about 250° F. or, alternatively, in a range of from about 100° F. to about 250° F.

Gases that can be used to foam embodiments of the cement compositions of the present invention may include, but are not limited to, air, nitrogen, or combinations thereof. In general, the gas may be included in the cement composition in an amount sufficient to foam the composition. For example, the gas may be included in an amount in a range of from about 10% to about 40% by volume of the cement composition.

In some embodiments, the cement composition may further comprise a foaming agent. Examples of suitable foaming agents include, but are not limited to, mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; hydrolyzed keratin; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant; and combinations thereof. Where used, the foaming agent may be present in embodiments of the cement compositions of the present invention in an amount sufficient to provide a suitable foam. In some embodiments, the foaming agent may be present in an amount in the range of from about 0.1% and about 5% by volume of the water present in the cement composition.

As will be appreciated by those of ordinary skill in the art, embodiments of the cement compositions of the present invention may be used in a variety of subterranean operations, including primary and remedial cementing. In some embodiments, a cement composition may be provided that comprises water, cement, and a saponin. The cement composition may be introduced into a subterranean formation and allowed to set therein. As used herein, introducing the cement composition into a subterranean formation includes introduction into any portion of the subterranean formation, including, without limitation, into a well bore drilled into the subterranean formation, into a near well bore region surrounding the well bore, or into both.

In primary cementing embodiments, for example, embodiments of the cement composition may be introduced into a space between a wall of a well bore and a conduit (e.g., pipe strings, liners) located in the well bore, the well bore penetrating the subterranean formation. The cement composition may be allowed to set to form an annular sheath of hardened cement in the space between the well bore wall and the conduit. Among other things, the set cement composition may form a barrier, preventing the migration of fluids in the well bore. The set cement composition also may, for example, support the conduit in the well bore.

In remedial cementing embodiments, a cement composition may be used, for example, in squeeze-cementing operations or in the placement of cement plugs. By way of example, the composition may be placed in a well bore to plug an opening, such as a void or crack, in the formation, in a gravel pack, in the conduit, in the cement sheath, and/or a microannulus between the cement sheath and the conduit.

To facilitate a better understanding of the present invention, the following examples of certain aspects of some embodiments are given. In no way should the following examples be read to limit, or define, the entire scope of the invention.

### EXAMPLE 1

The following series of tests was performed to evaluate the use of yucca and quillaja extracts as set retarders for cement compositions. Sample cement compositions, designated Samples 1-13, were prepared that had a density of 16.4 lb/gal and comprised water, Portland Class H cement, and a source of saponins, as indicated in the table below. The source of saponins was either a yucca extract (Yucca AG AIDE 50, Desert King International) or a quillaja extract (Quillaja Extract, Desert King International). Comparative Sample 1 did not include the yucca extract. A defoaming agent (D-Air 4000L™ Cementing Defoamer, Halliburton Energy Services, Inc.) was also included in each sample in an amount of 0.04 gallons per 94-pound sack of the cement (“gal/sk”). After preparation, the sample compositions were cured in a water bath for 24 hours at the temperature indicated in the table below and at ambient pressure.

The compressive strengths and thickening times exhibited by the sample compositions are set forth in the table below. Compressive strengths were determined after curing using a Tinius Olsen tester in accordance with API RP 10B-2, Recommended Practice for Testing Well Cements. The thickening times (time to 70 Bc) were also determined in accordance with API RP 10B-2, Recommended Practice for Testing Well Cements.

TABLE 1

| | | | Yucca | Quillaja | | Thick. | 24 Hr Comp. |
|---|---|---|---|---|---|---|---|
| | Water | Cement | Extract | Extract | Temp. | Time | Strength |
| Sample | (gal/sk) | (% bwoc) | (gal/sk) | (gal/sk) | (° F.) | (hr:min) | (psi) |
| 1 | 4.4 | 100 | — | | 140 | 1:43 | — |
| 2 | 4.39 | 100 | 0.024 | | 140 | 4:23 | 1054 |
| 3 | 4.39 | 100 | — | 0.024 | 140 | 5:03 | |
| 4 | 4.41 | 100 | 0.049 | | 140 | 12:11 | — |
| 5 | 4.37 | 100 | 0.098 | | 140 | 27:41 | — |
| 6 | 4.37 | 100 | 0.049 | | 180 | 7:06 | — |
| 7 | 4.37 | 100 | 0.0735 | | 180 | 16:45 | — |
| 8 | 4.37 | 100 | 0.098 | | 180 | 27:52 | — |
| 9 | 4.37 | 100 | 0.0735 | | 200 | 8:21 | — |
| 10 | 4.37 | 100 | 0.098 | | 250 | 1:52 | — |
| 11 | 4.37 | 100 | 0.15 | | 250 | 2:37 | — |
| 12 | 4.21 | 100 | 0.25 | | 250 | 2:56 | — |
| 13 | 4.21 | 100 | — | 0.25 | 250 | 4:21 | — |

Example 1 thus indicates, inter alia, that the yucca and quillaja extracts can function as set retarders over a broad range of temperatures. For example, thickening times up to 27 hours and 41 minutes were obtained at a temperature of 140° F. while thickening times up to 27 hours and 52 minutes were obtained at 180° F. Moreover, a thickening time of around 2 hours or more was obtained at temperatures as high as 250° F.

### EXAMPLE 2

The following series of tests was performed to evaluate the use of yucca and quillaja extracts in foamed cement compositions, designated Samples 14-18. Base cement slurries were prepared that had a density of 16.4 lb/gal and comprised water (39.4% by weight of cement), Portland Class H cement, and a source of saponins. The source of saponins was either yucca extract (Yucca AG AIDE 20 or Yucca AG AIDE 50, both from Desert King International) or a quillaja extract (Quillaja Extract, Desert King International), as indicated in the table below. Sample 16 further included calcium chloride in an amount of 2% by weight of cement. The base cement slurries were then foamed down to the target density by mixing in a foam blending jar for 15 seconds. The actual density after mixing for 15 seconds is reported in the table below. After preparation, the samples were cured in a water bath for the time indicated in the table below at 140° F. and ambient pressure.

The compressive strengths exhibited by the sample compositions are set forth in the table below. Compressive strengths were determined after curing using a Tinius Olsen tester in accordance with API RP 10B-2, Recommended Practice for Testing Well Cements. The density of the middle, top, and bottom of each sample was also determined and reported in the table below.

TABLE 2

| | | Target | 15-Second | Yucca | Yucca | | 140° F | | | | |
|---|---|---|---|---|---|---|---|---|---|---|---|
| | Base | Foam | Foam | AG | AG | Quillaja | Comp. | | Foam Stability | | |
| | Density | Density | Density | AIDE 20 | AIDE 50 | Extract | Strength | Time | Top | Middle | Bottom |
| Sample | (lb/gal) | (lb/gal) | (lb/gal) | (% bvow) | (% bvow) | (% bvow) | (psi) | (days) | (lb/gal) | (lb/gal) | (lb/gal) |
| 14 | 16.4 | 15.2 | 15.56 | 2 | — | — | 1656 | 3 | 14.13 | 14.39 | 14.86 |
| 15 | 16.4 | 15.2 | 15.34 | 3 | — | — | 2470 | 3 | 13.92 | 14.13 | 14.52 |
| 16 | 16.4 | 15.2 | 14.53 | — | 2 | — | 2040 | 5 | 13.95 | 14.31 | 14.53 |
| 17 | 16.4 | 14.5 | 13.68 | — | 3 | — | Not set | 7 | — | — | — |
| 18 | 16.4 | 14.5 | 14.77 | — | — | 3 | 1420 | 5 | 13.79 | 14.17 | 14.64 |

Example 2 thus indicates, inter alia, that yucca and quillaja extracts can function as foaming agents. As illustrated by Table 2 above, stable foams were formed using from 2% to 3% of the yucca and quillaja extracts by volume of the water.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method of cementing in a subterranean formation, comprising:
introducing a cement composition into a subterranean formation, wherein the cement composition comprises cement, water, and a saponin; and
allowing the cement composition to set in the subterranean formation.

2. The method of claim 1, wherein the cement comprises a hydraulic cement selected from the group consisting of a Portland cement, a pozzolana cement, a gypsum cement, a high-alumina content cement, a slag cement, a silica cement, and any combination thereof.

3. The method of claim 1, wherein the cement comprises a Portland cement.

4. The method of claim 1, wherein the water is present in an amount sufficient to form a pumpable slurry.

5. The method of claim 1, wherein the saponin comprises at least one saponin selected from the group consisting of a yucca saponin, a quillaja saponin, a legume saponin, an oat saponin, an allium saponin, an asparagus saponin, a tea saponin, a spinach saponin, a sugarbeet saponin, a yam saponin, a fenugreek saponin, an alfalfa saponin, a horse chestnut saponin, a licorice saponin, a soapwort saponin, a gypsophila saponin, a sarasparialla saponin, a ginseng saponin, an any combination thereof.

6. The method of claim 1, wherein the saponin comprises a yucca saponin.

7. The method of claim 1, wherein the saponin comprises a steroidal aglycone and a chain comprising a water-soluble carbohydrate.

8. The method of claim 1, wherein the saponin comprises a quillaja saponin.

9. The method of claim 1, wherein the saponin is present in the cement composition in an amount in a range of from about 0.01% to about 5% by weight of the cement.

10. The method of claim 1, wherein the saponin is present in the cement composition an amount of about 0.1% to about 2% by weight of the cement.

11. The method of claim 1, wherein the cement composition further comprises at least one additive selected from the group consisting of a strength-retrogression additive, a set accelerator, a weighting agent, a lightweight additive, a gas-generating additive, a mechanical property enhancing additive, a lost-circulation material, a filtration-control additive, a dispersant, a fluid loss control additive, a defoaming agents, a foaming agent, a thixotropic additive, and any combination thereof.

12. The method of claim 1, wherein the cement composition further comprises a set retarder in addition to the saponin.

13. The method of claim 1, wherein the saponin retards the set of the cement composition.

14. The method of claim 1, wherein the saponin functions in the cement composition as a dual set retarder and a foaming agent, the method further comprising foaming the cement composition with a gas to a density in a range of from about 4 pounds per gallon to about 16 pounds per gallon.

15. The method of claim 1, wherein the saponin functions as a set retarder, the cement composition having a thickening time in a range of from about 1 hour to about 40 hours at a temperature of from about 100° F. to about 300° F.

16. The method of claim 1, wherein the saponin is used to foam the cement composition.

17. The method of claim 1, wherein introducing the cement composition into the subterranean formation comprises introducing the cement composition into a space between a wall of a well bore and a conduit located in the well bore.

18. A method of cementing in a subterranean formation, comprising:
introducing a cement composition into a subterranean formation, wherein the cement composition comprises cement, water, and a yucca extract, wherein the yucca extract comprises yucca saponins; and
allowing the cement composition to set.

19. The method of claim 18, wherein the cement comprises a hydraulic cement selected from the group consisting of a Portland cement, a pozzolana cement, a gypsum cement, a high-alumina content cement, a slag cement, a silica cement, and any combination thereof.

20. The method of claim 18, wherein the cement comprises a Portland cement.

21. The method of claim 18, wherein the water is present in an amount sufficient to form a pumpable slurry.

22. The method of claim 18, wherein the yucca extract is present in the cement composition in an amount in a range of from about 0.01% to about 10% by weight of the cement.

23. The method of claim 18, wherein the cement composition further comprises at least one additive selected from the group consisting of a strength-retrogression additive, a set accelerator, a weighting agent, a lightweight additive, a gas-generating additive, a mechanical property enhancing additive, a lost-circulation material, a filtration-control additive, a dispersant, a fluid loss control additive, a defoaming agents, a foaming agent, a thixotropic additive, and any combination thereof.

24. The method of claim 18, wherein the cement composition further comprises a set retarder in addition to the yucca extract.

25. The method of claim 18, wherein the yucca extract retards the set of the cement composition.

26. The method of claim 18, wherein the yucca extract functions in the cement composition a dual set retarder and a foaming agent, the method further comprising foaming the cement composition with a gas to a density in a range of from about 4 pounds per gallon to about 16 pounds per gallon.

27. The method of claim 18, wherein the yucca extract functions as a set retarder, the cement composition having a thickening time in a range of from about 1 hour to about 40 hours at a temperature of from about 100° F. to about 300° F.

28. The method of claim 18, wherein the yucca extra is used to foam the cement composition.

29. The method of claim 18, wherein introducing the cement composition into the subterranean formation comprises introducing the cement composition into a space between a wall of a well bore and a conduit located in the well bore.

30. A subterranean cement composition comprising:
a cement,
water, and
a saponin.
